(19) United States
(12) Patent Application Publication
(10) Pub. No.: US 2009/0021784 A1
(43) Pub. Date: Jan. 22, 2009

(54) Device and Method for Print Control

(75) Inventors: Jun Hoshii, Nagano-ken (JP); Hisanori Nakajima, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/167,053

(22) Filed: Jul. 2, 2008

(30) Foreign Application Priority Data
Jul. 18, 2007 (JP) 2007-187546

(51) Int. Cl. G06F 3/12

(52) U.S. Cl. 358/1.15

(57) ABSTRACT

A print control device that controls execution of a printing operation for a printing medium, includes an instruction information acquiring unit that acquires an image of a printing instruction medium and acquires image modification instruction information and printing medium instruction information according to the image; an image modification unit that modifies an image data to be printed based on at least the image modification instruction information; and a printing instruction unit that is operable of issuing a printing instruction so that a printing of the image data is carried out on the printing medium specified based on the printing medium instruction information.

The entire disclosure of Japanese Patent Application No. 2007-187546, filed Jul. 18, 2007, is expressly incorporated by reference herein.

### BACKGROUND

1. Field of the Invention

The present invention relates to a technique of printing image data by a desired printing instruction.

2. Related Art

Printers carry out various correction processes and adjustment processes in output of images so that more suitable images are delivered. For example, JP-H08-32827 proposes a technique of appropriately correcting luminance, contrast, color balance, etc. of image data and thereafter delivering the corrected image data. Japanese Patent No. 3319727 proposes a technique of gradating an image or emphasizing an image contour according to an object to be taken as the image so that the image is corrected so as to have an agreeable impression. Furthermore, recently, JP-A-2003-032609 proposes a technique of adjusting luminance or color shade of an image based on information about characteristics of a used digital camera, information about exposure during shooting and the like, thereby delivering more agreeable images.

However, it has been difficult for users to instruct specific parameters indicative of image processes such as luminance, contrast and color balance of image data. More specifically, users need to have knowledge about to what degree parameters should be adjusted so that a desired image quality can be achieved. It is also difficult for users to give appropriate instructions about a size and quality of desired printing paper as well as the parameters for image processing. For example, even when “A4 size” or “2L size” is displayed on a UI screen in instruction of printing paper size, there is a problem that the user cannot intuitively recognize the size of printing paper. Regarding the quality of printing paper, furthermore, there is a problem that the user cannot intuitively make the connection between the name of paper displayed on the UI screen and actual touch, harness, glaze and weight, whereupon there is a problem that a suitable printing paper cannot be instruction.

### SUMMARY

The present invention discloses a print control device that controls execution of a printing operation on a printing medium, includes: an instruction information acquiring unit that acquires an image of a printing instruction medium and acquires image modification instruction information and printing medium instruction information according to the image; an image modification unit that modifies an image data to be printed based on at least the image modification instruction information; and a printing instruction unit that is operable of issuing a printing instruction so that a printing of the image data is carried out on the printing medium specified based on the printing medium instruction information.

### BRIEF DESCRIPTION OF THE DRAWINGS

FIG. 1 is a perspective view of a printer of one embodiment to which a print control device of the present invention is applied;

FIG. 2 is a perspective view of the printer, showing the condition where a manuscript platen cover mounted on the top of the printer is opened so that a manuscript image is entered;

FIG. 3 is a perspective view of the printer, showing the condition where the front side of a scanner is lifted and turned;

FIG. 4 illustrates an inner structure of the printer;

FIG. 5 illustrates a plurality of nozzles discharging ink drops into ink discharge heads of respective colors;

FIG. 6 is a flowchart showing an image printing process to be carried out by a printer driver;

FIG. 7 is a flowchart showing a condition setting process;

FIG. 8 illustrates UI sheets;

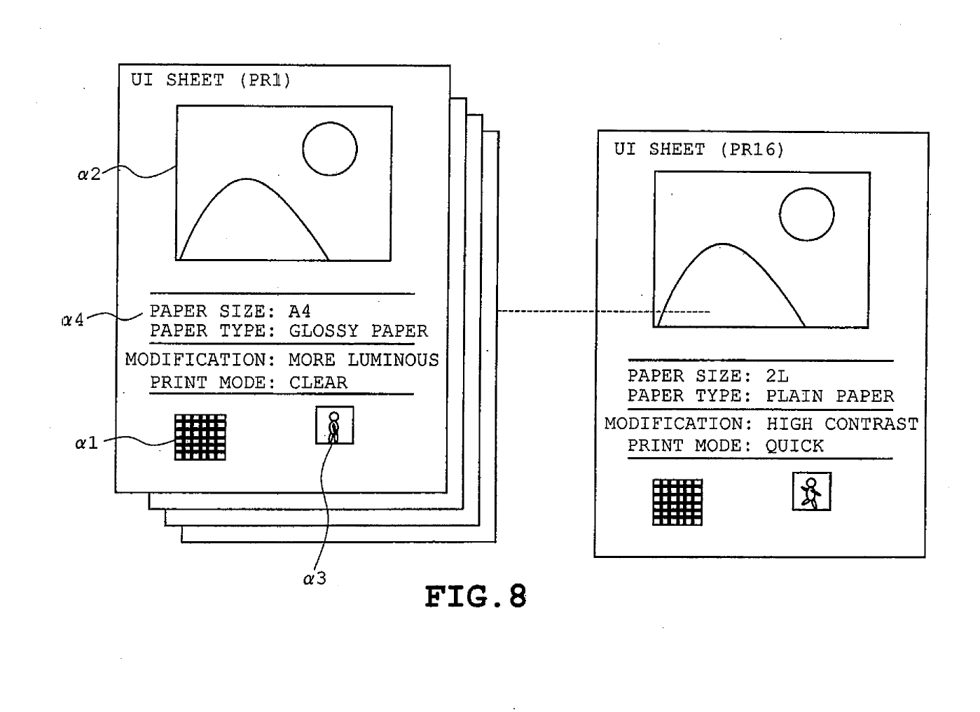

FIG. 9 shows a list of sets of instruction information;

FIG. 10 is a flowchart showing an image modification process;

FIGS. 11A, 11B and 11C show conversion in the image modification process;

FIG. 12 is a flowchart showing a print data generating process;

FIG. 13 is a partially enlarged view of dither matrix;

FIG. 14 shows a step of determining whether dot formation should be carried out for every pixel with reference to the dither matrix or not;

FIG. 15 illustrates an inner structure of the printer of a second modified form;

FIG. 16 is a flowchart showing a condition setting process in a third modified form;

FIG. 17 is a flowchart showing a condition setting process in a fourth modified form;

FIG. 18 shows a UI sheet of a modified form;

FIG. 19 also shows a UI sheet of another modified form;

FIG. 20 shows a UI sheet of further another modified form; and

FIG. 21 shows a UI sheet of still further another modified form.

### DESCRIPTION OF EXEMPLARY EMBODIMENTS

An embodiment will be described in the following sequence in order that the present invention briefly explained above may be described in more detail.

A. Device configuration:
A-1. Overall configuration:
A-2. Inner configuration:
A-2-1. Inner configuration of a scanner:
A-2-2. Inner configuration of a printing section:

B. Image printing process:
B-1. Condition setting process:
B-2. Painting process:
B-3. Print data generating process:

C. Summary

D. First modified form:

E. Second modified form:

F. Third modified form:

G. Fourth modified form:

H. Modified forms of UI sheet

### A. Device Configuration

### A-1. Overall Configuration

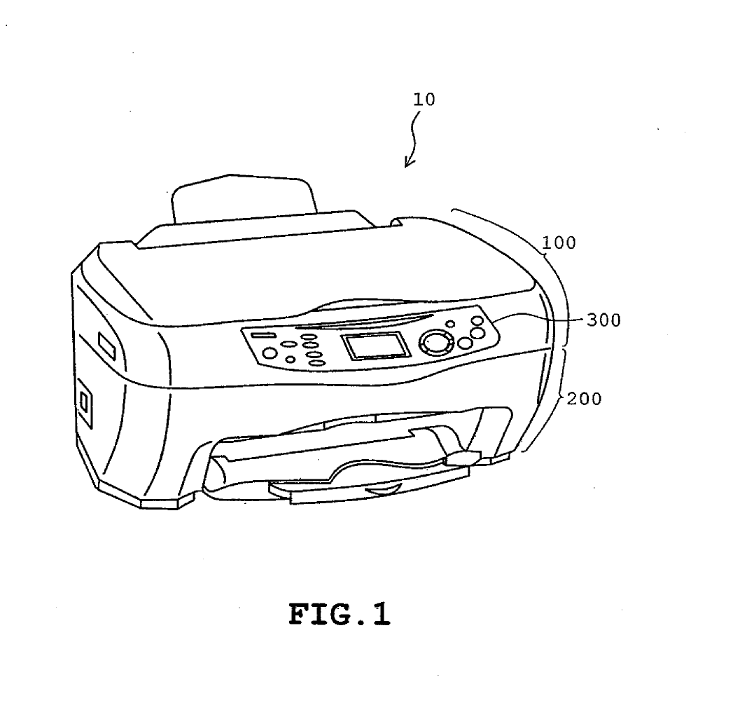

FIG. 1 is a perspective view of a printer 10 of an embodiment. As shown, the printer 10 of the embodiment comprises a scanner section 100, a printing section 200, an operation panel 300 for setting operations of the scanner section 100 and the printing section 200. The printer 10 includes every configuration of a print control device of the present invention, and a print control method of the present invention is realized by the printer 10. The scanner section 100 has a scanning function of reading a printed image and generating image data. The printing section 200 has a printing function of receiving the image data and printing the image on a printing medium. Furthermore, when the image (manuscript image) read by the scanner section 100 is delivered by the printing section 200, a copying function can be realized. More specifically, the printer 10 of the embodiment can realize scanning, printing and copying functions by itself and is accordingly a scanner-printer-copier combined apparatus (hereinafter, “SPC combined apparatus”).

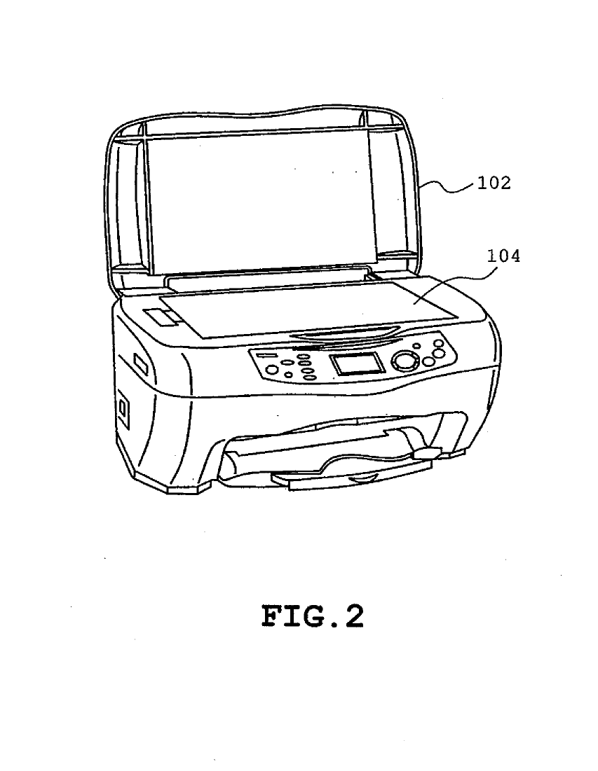

FIG. 2 is a perspective view of the printer 10, showing the condition where a platen cover 102 mounted on the top of the printer 10 is opened so that a manuscript image is entered. As shown, when the manuscript platen cover 102 is opened upward, a transparent platen glass 104 can be seen as provided. Inside the platen glass 104, various mechanisms for realizing the scanning function are provided as will be described later. When a manuscript image is to be entered, the manuscript platen cover 102 is opened as shown, and a manuscript image is set on the platen glass 104. The manuscript platen cover 102 is then closed, and a button on the operation panel 300 is operated, whereupon the manuscript image can promptly be converted into image data.

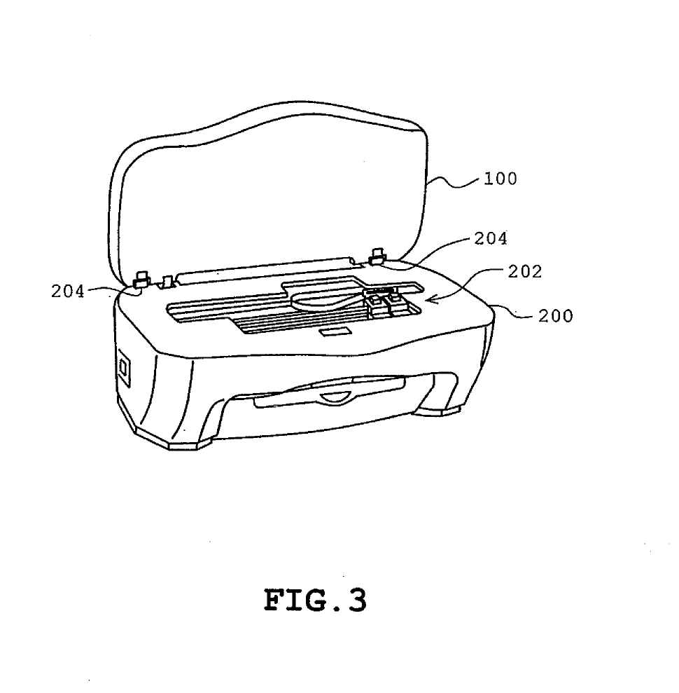

Furthermore, the entire scanner section 100 is enclosed in an integral case. The scanner section and the printing section 200 are connected to each other by a hinge mechanism 204 (see FIG. 3) in the rear side of the printer 10. Accordingly, when the front side of the scanner section 100 is lifted up, only the scanner section 100 can be turned by the hinge.

FIG. 3 is a perspective view of the printer, showing the condition where the front side of a scanner is lifted and turned. As shown, an upper surface of the printing section 20 can be exposed when the front side of the scanner section 100 is lifted up. Inside the printing section 200 are provided various mechanisms realizing the printing function as will be described later, a control circuit 260 for controlling an entire operation of the printer 10 including the scanner section 100 as will be described later, and a power supply circuit (not shown) supplying electric power to scanner section 100, the printing section 200 and the like. Furthermore, as shown in FIG. 3, an opening 202 is formed in the upper surface of the printing section 200 so that replacement of consumed parts such as an ink cartridge, jam disposal, and other minor repair can easily be carried out.

### A-2. Inner Configuration:

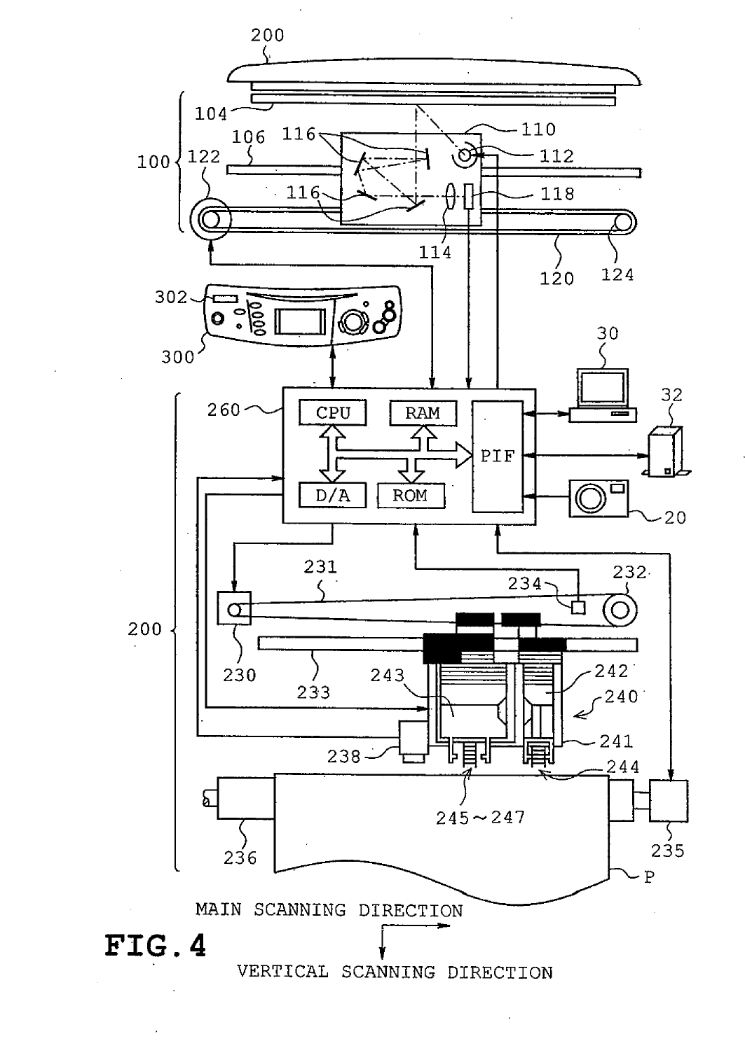

FIG. 4 illustrates an inner structure of the printer. The printer 10 is provided with the scanner section 100 and the printing section 200 as described above. Various configurations for realizing the scanning function are provided in the printing section 200. In the following, the inner configuration of the scanner section 100 will first be described and then, the inner configuration of the printing section 200 will be described.

### A-2-1. Inner Configuration of a Scanner:

The scanner section 100 includes the transparent platen glass 104 on which the manuscript image is set, the manuscript platen cover 102 for pressing the set manuscript image, a scanning carriage 110 for scanning the manuscript image, a drive belt 120 moving the scanning carriage 110 in a scanning direction (a direction in which the carriage 110 is moved, namely, a main scan direction of the scanning carriage 110), a drive motor 122 supplying drive power to the drive belt 120, and a guide shaft 106 guiding the scanning carriage 110. The drive motor 122 and the scanning carriage 110 are controlled by the control circuit 260 as will be described later.

When the drive motor 122 is rotated under the control of the control circuit 260, rotation is transmitted via the drive belt 120 to the scanning carriage 110. As a result, the scanning carriage 110 is moved in the scanning direction (in the main scan direction) according to a rotation angle of the drive motor 122 while being guided by the guide shaft 106. Furthermore, the drive belt 120 is normally adjusted into a suitably tightened state by an idler pulley 124. Accordingly, when the drive motor 122 is reverse rotated, the scanning carriage 110 can be moved in the reverse direction by a distance according to a rotation angle of the drive motor 122.

Inside the scanning carriage 110 are provided a light source 112, a lens 114, a mirror 116, a charge-coupled device (CCD) sensor 118 and the like. The manuscript platen glass 104 is irradiated with light emitted from the light source 112. The light is reflected on the manuscript image set on the manuscript platen glass 104. The reflected light is led to the lens 114 by the mirror 116, collected by the lens 114 and detected by the CCD sensor 118. The CCD sensor 118 comprises linear sensors arranged in a line in a direction intersecting the moving direction (main scan direction) of the scanning carriage 110. Thus, while the scanning carriage 110 is moved in the main scan direction, the manuscript image is irradiated with the light from the light source 112, so that the intensity of reflected light is detected by the CCD 118, whereby electrical signals corresponding to the manuscript image can be obtained.

Furthermore, the light source 112 comprises light-emitting diodes of three colors, red, green and blue (RGB) which are arranged to emit red, green and blue light sequentially for every predetermined period. The CCD 118 is arranged to detect the reflect light of red, green and blue colors sequentially. In general, red light is reflected on a red part of the image although green or blue light is not almost reflected. Accordingly, reflected red light represents a red (R) component. In the same manner, reflected green light represents a green (G) component and reflected blue light represents a blue (B) component. Thus, a manuscript image is irradiated with light of RGB colors while the light of RGB colors is switched for every predetermined period. When the reflected light intensity is detected by the CCD 118 in synchronization with the switching of the light of RBG colors, R, G and B components of the manuscript image can be detected, whereupon a color image can be entered. Since the scanning carriage 110 is in motion while the color of the light emitted from the light source 112 is being switched, positions of the image where the respective RGB components are detected strictly differ from one another by an amount corresponding to an amount of movement of the scanning carriage 110. The differences can be corrected by image processing after the components have been entered.

### A-2-2. Inner Configuration of a Printing Section:

An inner configuration of the printing section will now be described. Inside the printing section 200 are provided the control circuit 260 controlling a whole operation of the printer 10, a print carriage 240 for printing the image on printing media, a mechanism for moving the print carriage 240 in the main scan direction, a mechanism for feeding the printing media, and the like.

The print carriage 240 comprises an ink cartridge 242 storing a black (K) ink, ink cartridges 243 storing cyan (C) ink, magenta (M) ink and yellow (Y) ink respectively, a print head 241 provided at the bottom side. The print head 241 is provided with ink discharge heads discharging ink drops of respectively colors. When the ink cartridges 242 and 243 are attached to the print carriage 240, inks of respective colors are supplied through guide pipes into the discharge heads 244 to 247 of respective colors.

The mechanism for moving the print carriage 240 to the main scan direction comprises a carriage belt 231 for driving the print carriage 240, a carriage motor 230 supplying drive power to the carriage belt 231, a tension pulley 232 normally imparting a suitable tension to the carriage belt 231, a carriage guide 233 guiding the movement of the print carriage 240, an origin position sensor 234 detecting an origin position of the print carriage 240, and the like. When the carriage motor 230 is rotated under the control of the control circuit 260 as will be described later, the print carriage 240 can be moved in the main scan direction by a distance corresponding to a rotation angle of the motor 230. Furthermore, when the carriage motor 230 is reverse rotated, the print carriage 240 can be moved in the reverse direction.

The mechanism for feeding the printing media comprises a platen 236 supporting the printing media at the back side and a paper feed motor 235 rotating the platen 236 so that printing media are fed. When the paper feed motor 235 is rotated under the control of the control circuit 260 as will be described later, the printing medium can be fed in the vertical direction by a distance corresponding to a rotation angle of the motor 235. Furthermore, the printing section 200 is provided with a plurality of paper trays so that a plurality of types (sizes) of printing paper can be set and fed. For example, the printing section 200 is provided with a card tray for feeding postcards and an ordinary tray for feeding A4 paper or the like, whereupon a suitable paper can be fed under the control of the control circuit 260.

The control circuit 260 comprises a central processing unit (CPU) as a main component, a read only memory ROM), a random access memory (RAM), a digital/analog (D/A) converter converting digital data to analog signals, a peripheral interface (PIF) provided for data communication between peripheral equipment. The control circuit 260 controls the operation of the entire printer 10 including the light source 112 provided in the scanner section 100, the drive motor 122 and the CCD 118 while carrying out communication with these components.

Furthermore, the control circuit 260 supplies drive signals to ink discharge heads 244 to 247 of respective colors while driving a carriage motor 230 and a paper feed motor 235 to carry out the main scan and vertical scan of the print carriage 240 so that ink drops are discharged. Drive signals supplied to the ink discharge heads 244 to 247 respectively are generated by reading image data from the computer 30, the digital camera 20, an external storage unit 32 and the like and executing image processing as will be described later. Of course, drive signals can be generated by processing image data read by the scanner section 100. Thus, ink drops are discharged from the ink discharge heads 244 to 247 so that ink dots of respective colors are formed on the print medium, whereby a color image can be printed. Of course, the data processing need not be carried out in the control circuit 260. Data to which the image processing has been applied may be received from a computer. The ink discharge heads 244 to 247 may be driven while the main scan and vertical scan of the print carriage 240 are carried out according to the received data.

Furthermore, the control circuit 260 is also connected to the operation panel 300 so as to transmit and receive data to and from the operation panel 300. Various buttons on the operation panel 300 are operated so that detailed operation mode of a scanning, printing or other function can be set. Additionally, detailed operation modes may be set via the peripheral interface PIF at the computer 30.

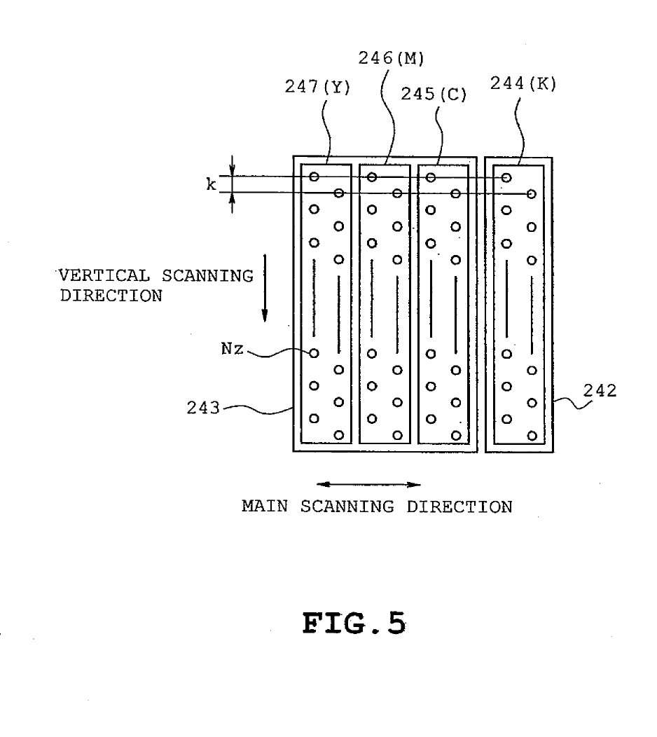

FIG. 5 illustrates a plurality of nozzles Nz discharging ink drops into the ink discharge heads 244 to 247 of respective colors. As shown, each ink discharge head has a bottom formed with four rows of nozzles discharging ink drops of respective colors. Each row includes 48 nozzles Nz formed into a zigzag arrangement with a nozzle pitch k. The control circuit 260 is adapted to deliver drive signals to the nozzles Nz respectively. The nozzles Nz are adapted to discharge ink drops of the colors according to the drive signals respectively.

As described above, the printing section 200 of the printer 10 delivers the drive signals to the respective ink discharge nozzles. Ink drops are discharged according to the respective drive signals so that ink dots are formed on a printing medium, whereby an image is printed. Furthermore, the control data on which the ink discharge nozzles are driven is generated by applying predetermined image processing to the image data prior to image printing. The following will describe image print processing by generating control data by application of image processing to image data and by forming ink dots based on the obtained control data.

### B. Image Printing Process:

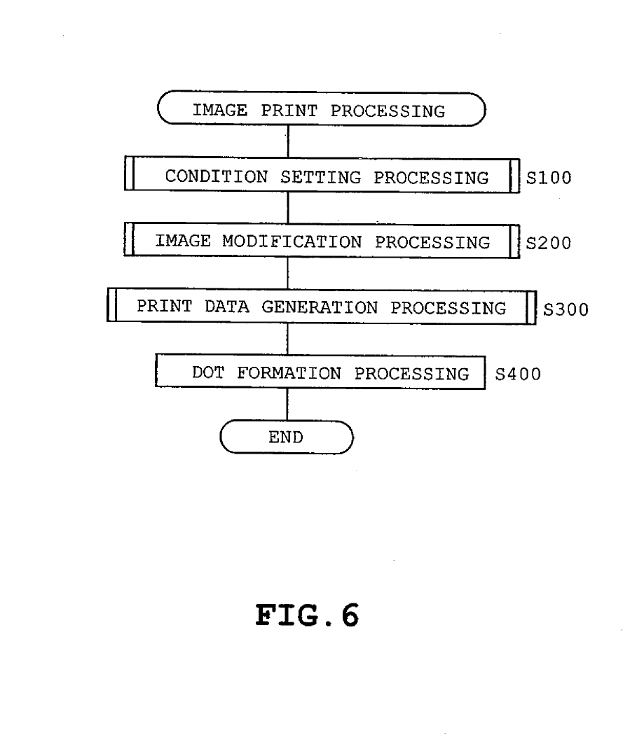

FIG. 6 is a flowchart showing an image printing process to be carried out by a printer driver. The process is carried out by the control circuit 260 provided in the printer 10 using the functions of the CPU, RAM, ROM and the like incorporated in the control circuit 260. More specifically, the control circuit 260 loads a firmware program recorded on the ROM. The firmware program is executed by the CPU while being developed into the RAM, so that the image printing is executed. Upon start of the image printing process as shown in FIG. 6, processing for setting various conditions (step S100) is firstly carried out. In execution of printing, printing conditions are received from the user. Various parameters are set which are used in the image modification processing (step S200) and a print data generating processing (step S300) which will be carried out later. The condition setting processing will be described in detail in B-1 later.

As shown in FIG. 6, upon start of the image print processing, an image modification processing is executed after condition setting processing (step S200) as shown in FIG. 6. In the image modification processing, a picture is made according to user's preference. The image modification means various correcting processes and adjusting processes applied to the image data in the output of the image. For example, the image modification includes a brightness correcting process in which an image is corrected so as to have a suitable brightness, a white balance process in which proportions of RGB colors are adjusted so that the image has a more suitable color shade. Of course, the image modification includes a delicate adjustment of the image appealing to emotional richness as well as the above-mentioned general correction processing.

Standard image modification software aimed at everyone is set in general printers in order that images satisfying as many people as possible may be printed. Accordingly, image modification is executed according to settings of the standard image modification software, and resultant images are printed. However, users have different tastes, and some users would like to carry out image modification agreeable to their tastes and print images. In such a case, a user starts up a personal computer, launching a photo re-touch software. The user then needs to carry out troublesome works which includes correcting image data and thereafter printing an image. Furthermore, even when the photo re-touch software is used, the image modification necessitates high-level knowledge about image correction, chromatics and the like. Thus, it is not actually so easy for ordinary users to carry out the image modification. Additionally, the image modification appealing to someone's instinct would almost belong to the realm of art. Desired image modification cannot be realized no matter how multifunctional the photo re-touch software is. On the other hand, the image modification processing of the embodiment realizes easily making a desired picture. Accordingly, the user can easily obtain a printed image of a picture made according to the user's taste without troublesome work. The image modification processing will be described in detail in section B-2.

A print data generating process is subsequently executed (step S300). In the print data generating process, image data to which the image modification processing has been applied is converted to print data which can be treated by the printer section 200. The print data is delivered so that the printer section 200 is instruction to execute printing and accordingly serves as printing instruction in the invention. The print data generated by sequentially executing resolution conversion, color conversion, halftone processing and interlace processing. The generation of print data will be described in detail in section B-3.

Upon completion of the print data generating processing, processing for actually forming dots on a printing medium according to the generated print data is initiated (step S400), as shown in FIG. 6. More specifically, the carriage motor 230 is driven so that data of dots rearranged is supplied to the ink discharge heads 244 to 247 while the print carriage 240 is being moved in the main scan direction. In this case, the paper feed motor 235 is driven so that the print medium set in the condition setting processing (step S100) is fed. As a result, ink drops are discharged from the ink discharge heads 244 to 247 according to the print data, whereby proper dots are formed for each pixel.

Upon completion of one time main scan, the paper feed motor 235 is driven so that the print medium is fed in the vertical scan direction, and thereafter, the carriage motor 230 is re-driven so that data of dots rearranged is supplied to the ink discharge heads 244 to 247 while the print carriage 240 is being moved in the main scan direction, whereby dots are formed. The above-described operations are executed repeatedly so that dots of colors, C, M, Y and K are formed on the print medium in a suitable distribution according to gradation values of the image data. Consequently, an image is printed.

### B-1. Condition Setting Processing

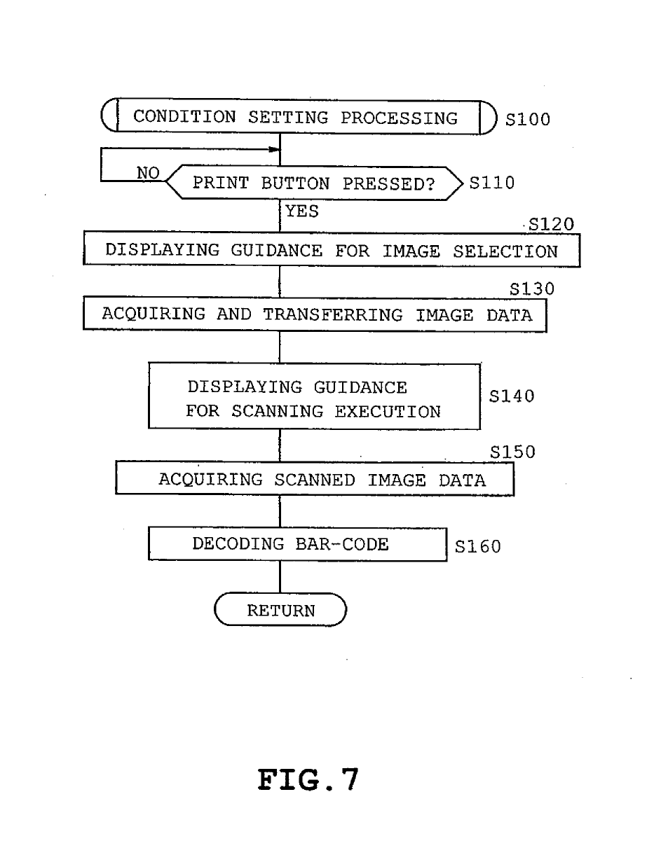

FIG. 7 is a flowchart showing the above-described condition setting process. Here, depressing of a print button provided on the operation panel 300 is detected (step S110). When the print button is depressed, an indication “Select image data to be printed and depress decision button” is displayed on a screen of the operation panel 300 as guidance display (step S120). In this case, a list of image data stored on a digital camera 20 and external storage unit 32 and thumbnails are displayed on the screen of the operation panel 300 in order that the user may select desired image data. When the decision button is depressed by the user, the selected image data is transferred to the RAM of the control circuit 260 (step S130). Subsequently, an indication “Set a desired user interface (UI) sheet and depress the scan button” is displayed on the screen of the operation panel 300 (step S140). The UI sheet serves as a printing instruction medium in the invention. When the scan button is depressed, the scanner section 100 is controlled in the same manner as described in section A-2-1 so that the UI sheet is scanned (image input), whereby the scanned image data is acquired as the result of input of the image on the UI sheet (step S150).

FIG. S shows an example of UI sheet. In the embodiment, sixteen types of UI sheets are prepared. The user selects a desired one of the UI sheets and sets the selected UI sheet on the platen glass 104. The following describes the configuration of UI sheet and rules in the configuration of UI sheet. In the embodiment, two types of printing papers, that is, glazed paper and plain paper both differing in the paper quality. Each type of printing paper includes A4 size and 2L size. A barcode α1, sample image α2, icon α3 and character α4 are printed on any paper. The barcode is specific to each UI sheet. Since the scanned image data contains an image of any one α1 of the sixteen types of UI sheets, the image of barcode α1 is detected from the scanned image data and is decoded to character information based on predetermined rule. The result of decoding is stored on the RAM (step S160). The barcode α1 may be a one-dimensional barcode such as JAN code or two-dimensional barcode such as QR code. The decoded character information indicates instruction information set.

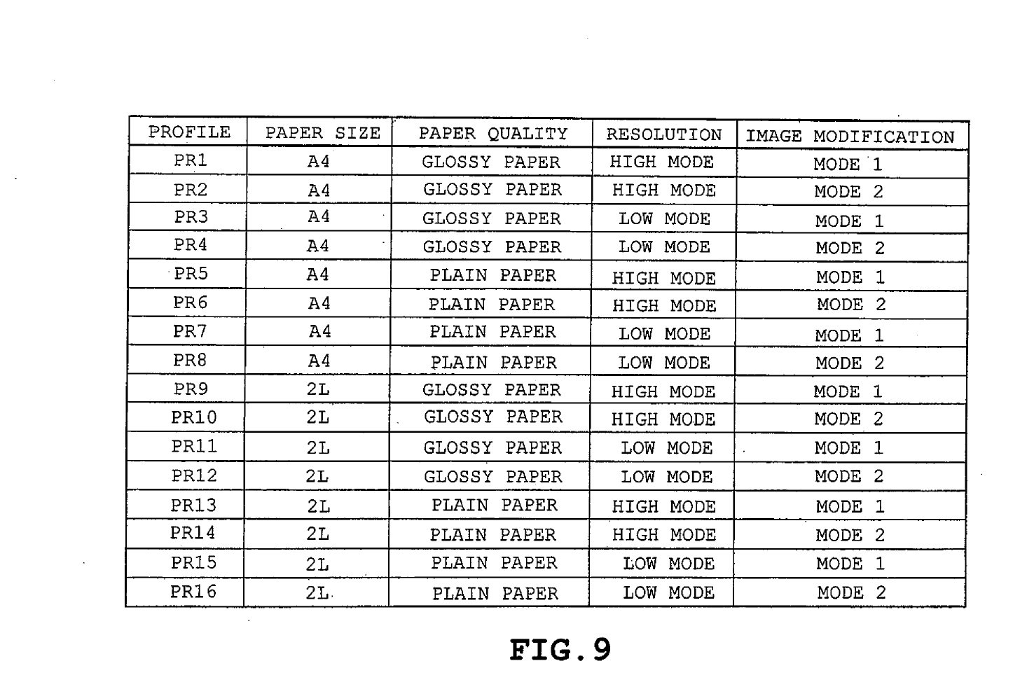

FIG. 9 shows an example list of sets of instruction information represented by the barcodes α1 of the respective UI sheets. In the embodiment, sixteen instruction information sets PR1 through PR16 include respective combinations of image modification instruction information, print resolution instruction information and print medium instruction information. Furthermore, the print medium instruction information includes paper size instruction and paper quality instruction. The image modification instruction information includes an image modification mode 1 (brighter) or image modification mode 2 (high contrast). The print resolution instruction information includes a high mode (1440×1440 dpi) or a low mode (720×720 dpi). The paper size instruction includes A4 size or 2L size. The paper quality instruction includes plain paper or glazed paper. The image modification instruction information, print resolution instruction information, paper size instruction and paper quality instruction are combined with each other so that sixteen instruction information sets PR1 through PR16 are prepared, and sixteen types of UI sheets corresponding to the respective instruction information sets PR1 to PR16.

It is prescribed that the barcode α1 indicative of each of instruction information sets PR1 to PR5 having A4 size instruction is printed on the UI sheet formed on A4 size printing paper. It is further prescribed that the barcode α1 indicative of each of instruction information sets PR9 to PR16 having 2L size instruction is printed on the UI sheet on 2L size printing paper. It is also prescribed that the barcode α1 indicative of each of instruction information sets PR1 to PR4 and PR9 to PR12 having instruction of glazed paper is printed on the UI sheet formed on glazed printing paper. It is further prescribed that the barcode α1 indicative of each of instruction information sets PR5 to PRS and PR13 to PR16 having instruction of plain paper is printed on the UI sheet formed on plain printing paper.

Here, the user selects a desired one of instruction information sets PR1 to PR16 of sixteen types of UI sheets. Firstly, when selecting the UI sheet indicative of one of the instruction information sets PR1 to PR16 instructing a desired paper size, the user selects the UI sheet having the same size as a printing medium on which the user would like to print. In the same way, when selecting the UI sheet indicative of one of instruction information sets PR1 to PR16 instructing a desired paper quality, the user selects the UI sheet having the same texture, touch and weight as the printing medium on which the user would like to print. Additionally, the characters α4 visibly printed on each UI sheet represent printing paper size instruction and paper quality instruction of instruction information sets PR1 to PR16 represented by the barcode α1. Accordingly, the user can determine whether the UI sheet corresponds to desired paper size instruction and paper quality instruction when viewing the characters α4.

Next, when selecting the UI sheet indicative of one of the instruction information sets PR1 to PR16 instructing a desired printing resolution, the user views a visibly printed icon α3 and character α4 to select a proper UI sheet. It is prescribed that characters α4 indicative of “clean” as well as icon α3 indicative of a walking person are shown on the UI sheet on which the barcode α1 is shown which represents instruction information sets PR1 and PR2, PR5 and PR6, PR9 and PR10 and PR13 and PR14 including high-mode print resolution instruction. On the other hand, it is prescribed that characters α4 indicative of “fast” as well as icon α3 indicative of a walking person are shown on the UI sheet on which the barcode α1 is shown which represents instruction information sets PR3 and PR4, PR7 and PR8, PR11 and PR12 and PR15 and PR16 including low-mode print resolution instruction. As a result, the user can intuitively select the UI sheet showing instruction information sets PR1 to PR16 including desired print resolution instruction by barcode α1, based on an image of icon α3 as well as the description of characters α4.

When selecting the UI sheet representing the instruction information sets PR1 to PR16 including desired image modification instruction information, the user views a sample image α2 and characters α4 both visibly printed thereby to be able to select a proper UI sheet. When the UI sheet shows a barcode α1 representing that the image modification instruction information is indicative of instruction information sets of image modification mode 1 (brighter) PR1, PR3, PR5, PR7, PR9, PR11, PR13 and PR15, it is prescribed that characters α4 of “brighter” are shown as well as a sample image α2 corrected so that a reference image is rendered brighter. In a case where a reference image is corrected so as to be brighter, brightness correction is carried out using tone curve TC1 in the image modification processing which will be described later.

When the UI sheet shows a barcode α1 representing that the image modification instruction information is indicative of instruction information sets of image modification mode 2 (high contrast) PR2, PR4, PR6, PR8, PR10, PR12, PR14 and PR16, it is prescribed that characters α4 of “high contrast” are shown as well as a sample image α2 corrected so that contrast is rendered higher than the reference image. In a case where a reference image is corrected so that the contrast thereof is increased, brightness correction is carried out using tone curve TC2 in the image modification processing which will be described later. The sample image α2 has been corrected so that the same reference image is rendered brighter or contrasted higher. Accordingly, while comparing both, the user can intuitively determine what image modification he or she likes.

According to the UI sheet prepared based on the above-described rules, the UI sheet meeting the conditions the user intuitively wishes to print can be selected. When the selected UI sheet is set on the platen glass 104 so as to be scanned, the instruction information sets PR1 to PR16 suitable for the user's desire can be recognized by the control circuit 260. The scanner section 100 scanning the UI sheet serves as an image input unit in the invention. The control circuit 260 decodes the instruction information sets PR1 to PR16 including the image modification information and print medium instruction information from the image of the barcode al. Thus, the control circuit 260 serves as an instruction information acquiring unit in the invention. When required as described above, the instruction information sets PR1 to PR16 are stored on the RAM, and the image modification process (step S200) in the main flow as shown in FIG. 6 is carried out.

### B-2. Image Modification Processing

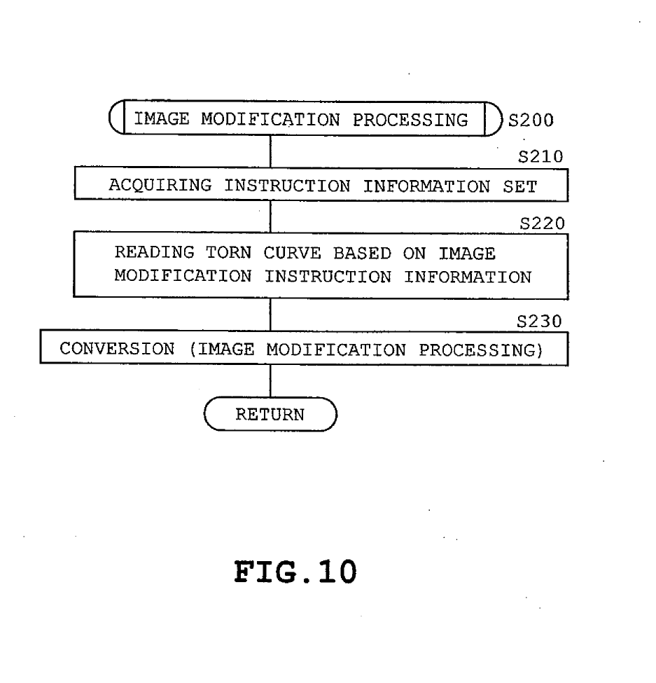

FIG. 10 is a flowchart showing the image modification processing in the embodiment. In the image modification processing, the instruction information sets PR1 to PR16 previously stored on the RAM (step S160) are read (step S210). In the following description, the UI sheet representative of the instruction information set PR1 is selected by the user. When the instruction information set PR1 has been read out image modification instruction (mode 1) instruction as image modification instruction information in the instruction information set PR1 is acquired, and the tone curve TC1 corresponding to mode 1 is read from the RAM (step S220). Conversion (S230) is carried out for the image data to be printed previously transferred to the RAM (step S130).

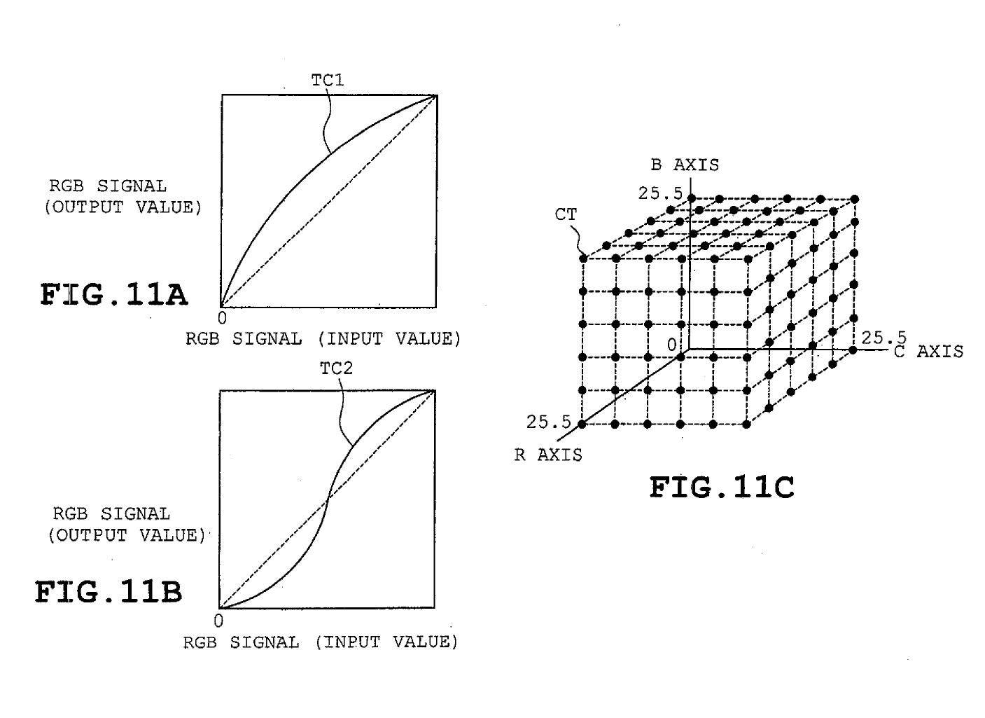

FIGS. 11A, 11B and 11C show conversion in the image modification processing. As described above, the image modification is carried out by applying correction processing and adjustment processing to image data. Accordingly, image modification may be regarded as image conversion from original image data to different image data. Prior to image modification, rules of conversion from original image data to image data reflecting image modification need to be instruction. In the embodiment, a tone curve is instruction as the conversion rule. FIG. 11A shows a tone curve with abscissa axes representing input values (gradation values of R, G and B) and axes of ordinates representing output values (gradation values of R, G and B).

As shown in FIGS. 11A-11C, there are previously set a tone curve TC1 performing brightness correction by upwardly revising the RGB gradation values of the image data uniformly and a tone curve TC2 performing a correction to increase contrast by correcting the RGB gradation values using an S-shaped curve. Either curve can selectively be applied. Furthermore, the tone curve TC1 is caused to relate with mode 1 of image modification instruction information, whereas tone curve TC2 is caused to relate with mode 2 of image modification instruction information. The tone curve TC1 is read out in the embodiment so that image data is converted using the tone curve TC1.

Additionally, as shown in FIG. 11B, a conversion table CT may be set so that an image represented by RGB gradation values is converted to other RGB values. In this case, it is supposed that the gradation values of the RGB colors ranges from 0 to 255. Furthermore, suppose a color space in which three intersecting axes represent RGB gradation values, as shown in FIG. 11B. In this case, all RGB image data can be caused to correspond to points inside a cube (color cube) having an origin serving as an apex and each side having a length of 255. When viewed from a different angle, the cube may be considered in the following. That is, when the color cube is divided at right angles to RGB axes into a lattice shape so that a plurality of lattice points are generated in the color space, the lattice points are considered to represent RGB image data. Then, in the case where combinations of RGB gradation values to which the image modification processing has been applied are previously stored on the respective lattice points (input values), the RGB image data can be converted to image data (RGB image data) reflecting image modification when the gradation values stored on the respective lattice points are read out.

For example, when an R component of image data is RA, a G component is GA and a B component is BA, the image data is caused to correspond to point A in the color space (see FIG. 11B). A cube dV including point A is detected from smaller cubes obtained by dividing the color space into the lattice configuration. A gradation value of each of post-conversion RGB color is read. The gradation values are stored on the lattice points of the cube dV. When an interpolation computation is carried out based on the gradation values of the respective lattice points, gradation values at point A can be obtained. As described above, the conversion table CT can be considered as a three-dimensional numeric table storing combinations of post-image modification RGB gradation values at the respective lattice points represented by combination of pre-image modification RGB gradation values. When the conversion table CT is referred to, conversion corresponding to the image modification can be carried out quickly.

In preparation of the conversion table CT, lattice points distributed uniformly in the whole RGB color space are converted by the tone curves TC1 and TC2, and the conversion table CT can be prepared by describing values before and after the conversion (input and output values). In the embodiment, two conversion tables CT corresponding to two tone curves TC1 and TC2 need to be prepared respectively. The tone curve TC1 is instruction in the embodiment, and image data is converted with reference to the conversion table CT generated based on the tone curve TC1. When the post-image modification image data as described above, a print data generating process (step S300) is then carried out. The control circuit 260 carries out image processing based on the image modification instruction information and accordingly serves as a part of printing instruction unit in the invention.

### B-3. Print Data Generating Processing

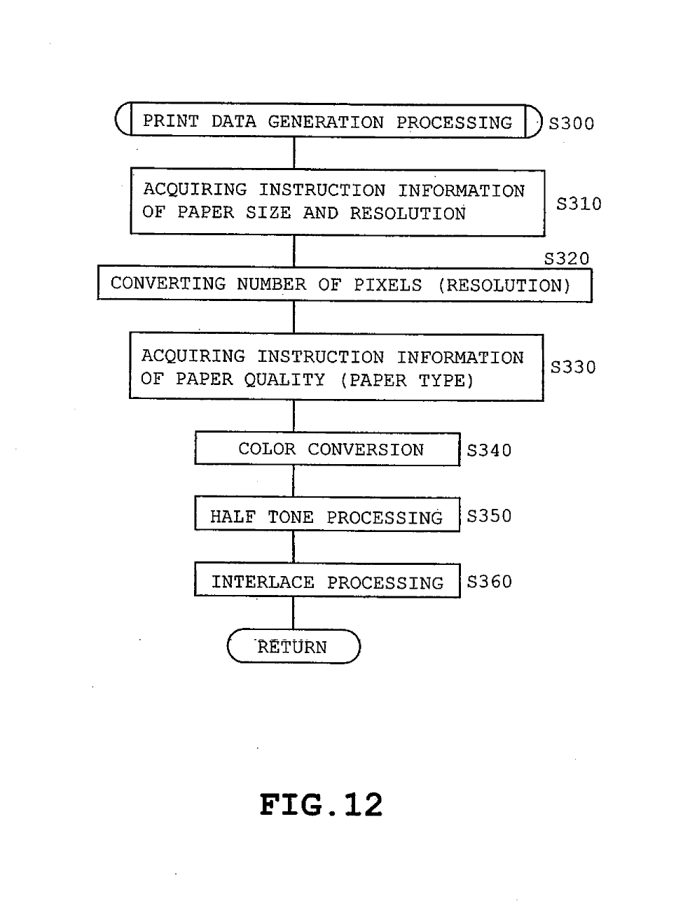

FIG. 12 is a flowchart showing print data generating processing. In the figure, firstly, print resolution instruction information (High Mode: 1440×1440 dpi) the paper size (A4) instruction as the printing medium instruction information in the instruction information set PR1 stored on the RAM (step S160) are acquired (step S310). Based on these pieces of information, a resolution of image data to be printed is processed to be converted to a resolution at which printing is carried out by the printer section 200 (the print resolution instruction the print resolution instruction information; and step S320). When the resolution of image data read at step S130 in FIG. 7 is lower than the print resolution, an interpolation computation is carried out between adjacent pixels so that new image data is set. As a result, the resolution is converted to one with a higher value. On the contrary, when the resolution of image data read at step S130 in FIG. 7 is higher than the print resolution, image data is thinned at a constant rate from between the pixels adjacent to each other in the read image data so that the resolution of the read image data is converted into a lower value. In the resolution conversion processing, image data is generated or thinned to or from the read image data at a suitable rate, whereby the read resolution is converted into a print resolution. Since the paper size and the print resolution have been acquired, the size of image data (the number of pixels) to be converted by the resolution conversion can be specified.

Subsequently, the control circuit 260 of the printer 10 acquires the paper quality (glazed paper) instruction as one piece of the print medium instruction information in the instruction information set PR1 stored (step S160) on the RAM (step S330). Subsequently, color conversion processing is carried out for the image data (step S340). The color conversion processing converts image data expressed by RGB colors into image data expressed by CMYK colors. The color conversion processing is carried out by referring to a three-dimensional numeric table called color conversion table (LUT). The color conversion table (LUT) is a three-dimensional numeric table in which post-conversion values are caused to correspond to three intersecting axes with respect to lattice points in the color space taking the RGB gradation values as in the above-described conversion table CT of FIG. 11B.

In the color conversion table (LUT), however, the combinations of the CMYK gradation values are caused to correspond to the respective lattice points. The color conversion table (LUT) differs from the conversion table CT in this respect. Conversion is carried out with reference to the color conversion table (LUT) in the same manner as by the conversion table CT, whereby RGB image data can quickly be converted to the CMYK image data (step S340). Two types of color conversion tables (LUT) are prepared in the embodiment. The color conversion is carried out using either color conversion table (LUT). In one of the color conversion tables (LUT), the CMYK gradation values are defined for the printing on glazed paper, whereas the CMYK gradation values are defined for the printing on plain paper. The CMYK gradation values are considered to correspond to amounts of ink of CMYK ink dots formed on printing paper in a dot forming processing (step S400). Since the glazed paper and plain paper differ from each other in a dot forming characteristic, a color conversion table (LUT) specific to each paper quality needs to be prepared. Accordingly, a color conversion table (LUT) is selected according to the previously selected (step S330) paper quality, and a color conversion (step S340) is carried out with reference to the selected color conversion table (LUT).

Upon completion of the color conversion processing, the control circuit 260 starts a halftone processing (step S350). The halftone processing will be described briefly. The CMYK image data acquired by the color conversion processing represents CMYK colors in a range of gradation value from 0 to 255. The printer section 200 forms dots thereby printing an image. Accordingly, processing is necessitated to convert CMYK image data represented by 256 shades of grey to image data (dot data) represented by presence or absence of dot. Thus, the halftone processing converts CMYK image data to dot data.

Various techniques such as error diffusion technique and dither method can be applied as a technique of carrying out the halftone processing. In the error diffusion technique, an error in gradation expression is produced in a pixel when the pixel has been determined as to the presence and absence of dot. The error is diffused to peripheral pixels. Furthermore, presence or absence of dot formation of each pixel is determined so that error diffused from the periphery is resolved. Furthermore, in the dither method, threshold values randomly-set in a dither matrix are compared with CMYK image data for every pixel. When the image data is larger than the threshold value, dot is formed on the pixel. When the threshold value is larger, no dot is formed on the pixel. Thus, dot data is acquired for every pixel. Although either error diffusion technique or dither method may be employed, the dither method is employed in the embodiment.

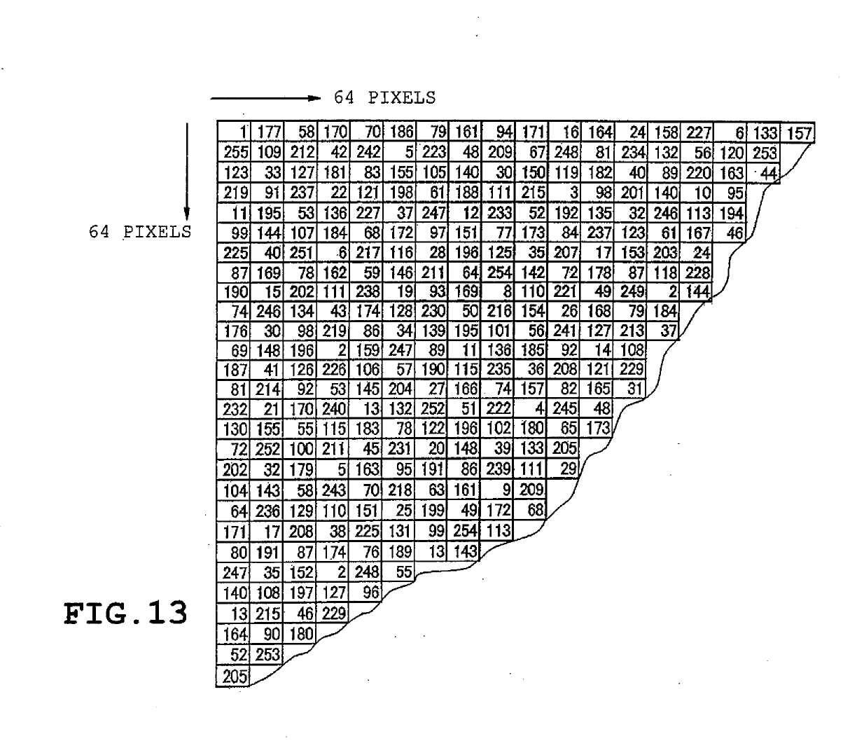

FIG. 13 is a partially enlarged view of a dither matrix. The shown matrix randomly stores threshold values uniformly selected from the range of gradation value from 0 to 255 on 64-by-64 pixels or the total of 4096 pixels. The threshold gradation values are selected from the range of 0 to 255 because the CMYK image data is single-byte data and the gradation value can take the value ranging from 0 to 255. The size of the dither matrix should not be limited to 64-by-64 matrix as shown in FIG. 13. The dither matrix may have various sizes including the size in which the number of lengthwise pixels and the number of crosswise pixels differ from each other.

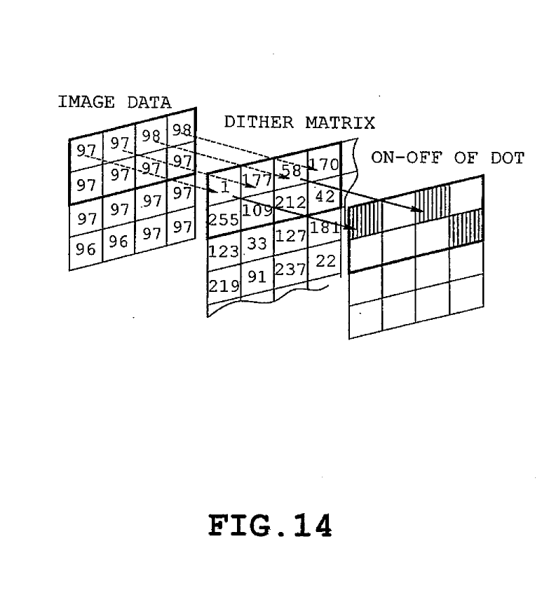

FIG. 14 shows a step of determining whether dot formation should be carried out for every pixel with reference to the dither matrix or not. The determination is carried out for every color of CMYK. In the following, the image data of CMYK are not distinguished from one another and will merely be referred to as “image data.”

In determining whether dots should be formed, a gradation value of image data with respect to a pixel on which attention is focused (focused pixel) is compared with a threshold value stored at a corresponding location in the dither matrix. A fine broken line arrow in the figure denotes that image data of focused pixel is being compared with a threshold value stored at a corresponding location in the dither matrix. When the image data of the focused pixel is larger than the threshold value of the dither matrix, it is determined that dots should be formed with respect to the pixel. On the contrary, when the threshold value is larger than the image data of the focused pixel, it is determined that no dots should be formed with respect to the pixel. In an example as shown in FIG. 14, image data of a pixel located at an upper left corner of the image is “97.” A threshold value stored at a location on the matrix corresponding to the pixel is “1.” Accordingly, it is determined that dots should be formed. A solid line arrow in FIG. 14 shows the condition where the result of determination is being written on a memory with the determination that dots should be formed.

On the other hand, regarding a pixel on the right of the aforenoted pixel, image data is “97” and a threshold value of the dither matrix is “177.” Since the threshold value is larger than the image data, it is determined that no dots should be formed. As described above, image data is compared with a threshold value set on the dither matrix, whereupon it can be determined for every pixel whether dots should be formed. In the halftone processing (step S350), the above-described dither method is applied to image data of each color of CMYK, whereby it is determined for every pixel whether dots should be formed and dot data generating processing is carried out.

When the halftone processing is carried out so that dot data is generated with respect to each color of CMYK, an interlace processing is then initiated (step S360). In the interlace processing, dot data is arranged in a sequence of dots are formed by a print head 241 and supplied to ink discharge heads 244 to 247 of respective colors. More specifically, as shown in FIG. 5, the ink discharge heads 244 to 247 includes respective nozzles Nz disposed in the vertical direction at intervals of nozzle pitch k. Accordingly, when ink drops are discharged while the print carriage 240 is moved in the main scan direction, dots are formed at intervals of nozzle pitch k in the vertical direction. In order that dots may be formed with respect to all the pixels, a relative position of the print carriage 240 and the printing medium needs to be shifted in the vertical direction so that new dots are formed with respect to the pixel between dots spaced from each other by the nozzle pitch k. Thus, when an image is actually printed, dots are not formed sequentially from an upper pixel on the image. Furthermore, dots are not formed by one main scan with respect to pixels in the same row but dots are formed by a plurality of times of main scan from the demand of image quality. As a result, dots are formed on pixels which are spaced away from each other in each main scan.

Accordingly, processing is necessitated in which prior to actual dot forming, dot data obtained with respect to each color of CMYK is arranged in a sequence that the ink discharge heads 244 to 247 form dots. This processing is referred to as an interlace processing. Upon completion of the interlace processing, dot data arranged by the interlace processing is generated as print data (printing instruction). Sine the instruction of printing paper read from the scanned image data (step S400) is also attached to the print data, printing media intended by the user can be fed at the above-described dot forming processing (step S400). When the printing paper corresponding to the instruction printing paper is not set in a paper-feed tray, warning display may be carried out on the operation panel 300. As described above, in the print data generating processing, image processing is sequentially carried out for the post-image modification image data based on instruction information set including the image modification instruction information and printing medium instruction information, whereupon the print data is finally generated after the interlace processing. In this sense, the control circuit 260 executing print data generating processing serves as a part of printing instruction unit in the invention.

### C. Summary

In the embodiment, when the user selects a desired UI sheet and the scan is carried out, image data is printed on printing paper with the same size and same paper quality as the selected UI sheet. Likewise, when the user selects a desired UI sheet and the scan is carried out, an image can be printed based on image data to which the image modification similar to a sample image displayed on the selected UI sheet. Thus, the user can intuitively select a desired UI sheet, and for example, parameters for image processing etc. need not be directly instruction. Although the printer of the embodiment has been described, the invention should not be limited by the above-described embodiment and modified forms of the embodiment. The invention can be practiced in various forms without departing from the gist thereof

The UI sheet is exemplified in the foregoing embodiment. The UI sheet is representative of instruction information sets PR1 to PR16 comprising four instruction items for the purpose of simplification of description. However, the UI sheet should not be limited to the image modification information and the print medium instruction information. More specifically, there are many conditions to be instruction in the printing. These conditions may be instruction by the UI sheet. For example, an ink set used in the printing may be instruction. The UI sheet may designate the main scan system of the carriage 240 (unidirection/bidirection), the layout instruction (allocation instruction or brink instruction), the number of sheets of printing paper or paper ejection/paper feed. When instruction information set including these pieces of instruction information is encoded into the barcode α1 to be printed, printing can be carried out according to the instruction information.

In the foregoing description, two types of instruction conditions are exemplified for every instruction items for simplification of description. However, more conditions may be instruction, and it is desirable to be able to instruct more types of conditions. For example, the paper size may include A3, B4, B5, letter size, postcard, L and roll paper as well as A4/2L. In the same way, the printing medium types may include matt paper, disc label of CD or DVD/seal or the like. Furthermore, the image modification instruction may include sharpness correction/unsharpness correction), noise correction/edge enhancement correction/color balance correction/color tone correction/red-eye effect correction. These pieces of image modification instruction information may be configured to be capable of instructing a degree of each correction as well as execution of each correction. A combination of a plurality of corrections and degrees of the corrections may be instruction. For example, a combination of a plurality of corrections and degrees of the corrections may be preset so that a picture is made so as to resemble to the style of a famous painter.

In the foregoing embodiment, all the instruction information sets PR1 to PR16 can be instruction if 16 UI sheets are prepared. Accordingly, it is possible to sell the printer 10 provided with the function of the invention with all the UI sheets being bundled. However, since available conditions in the actual printing are divergent as described above, the number of UI sheets prepared for every combination would become larger. Accordingly, UI sheets showing basic instruction information sets may initially be bundled with the printer 10, and UI sheets showing applied instruction information sets may be distributed separately or on the Internet. Since the printer 10 has a printing function, a UI sheet may be printed based on data downloaded via the Internet. For example, the UI sheet may be distributed which is printed with a barcode α1 instructing making a picture resembling to the style of a painter whose pictures are exhibited in a museum, or data which can be printed using a barcode α1 may be distributed by an electronic mail, file transmission protocol or the like. Furthermore, since at least the barcode α1 should be represented, the barcode α1 representing instruction information set may be carried on magazines, free-paper or the like.

In the invention, an image of printing instruction medium set on a platen is accepted. As a result, image information about the foregoing printing instruction medium can be obtained. The instruction information acquiring unit acquires image modification instruction information from the result of image input by the above-described image input. Furthermore, the instruction information acquiring unit also acquires printing medium instruction information from the image. More specifically, the aforesaid printing instruction medium represents the aforesaid image modification instruction information and the aforesaid print medium instruction information. The instruction information acquiring unit can acquire the aforesaid image modification instruction information and the aforesaid print medium instruction information by accepting an image of the printing instruction medium. The printing instruction unit executes image processing for the image data to be printed, based on the image modification instruction information and the print medium instruction information acquired as described above. The printing instruction unit further instructs the printing medium specified based on the printing medium instruction information, to print. Thus, only if the desired printing instruction medium is accepted, the printing can be carried out according to the image modification instruction information represented by the printing instruction medium and the printing medium instruction information. For example, the user is previously supplied with the image modification instruction information and a plurality of printing instruction media indicative of the printing medium instruction information. The user then selects the desired image modification instruction information and the printing instruction medium representative of the printing medium instruction information and causes the image to be accepted, whereupon the printing can be carried out according to the desired image processing instruction and printing medium instruction. The aforesaid image processing includes processing corresponding to the image modification in which brightness, color of the image data and the like are adjusted according to taste of a user or the like and processing corresponding to print data generation in which the image data is converted to print data the printer can treat.

The printing instruction medium is input as an image so that the image modification instruction information and the printing medium instruction information are acquired by the instruction information acquiring unit. However, these pieces of information can be acquired by various techniques. For example, the size of the printing instruction medium may be measured by inputting the printing instruction medium as an image by the image input unit. The size of the printing medium as the printing medium instruction information may be specified, based on the obtained measurement. More specifically, when it is prescribed that print of the image data is executed on the printing medium which has the same size as the printing instruction medium, the user selects and inputs, as an image, the printing instruction medium of the desired size, whereby printing can be executed on the printing medium with the desired size. Accordingly, the printing medium with a desired size can intuitively be instruction even if the user does not know the size (for example, A4 or 2L) of the printing medium the user wishes to print.

The type of the printing medium to be printed may be specified by the printing medium instruction information as well as the size of the printing medium. In this case, too, when it is prescribed that print of the image data is executed on the printing medium which is of the same type as the printing instruction medium, the user selects and inputs, as an image, the printing instruction medium of the desired type, whereby printing can be executed on the printing medium of the desired type. Accordingly, the printing medium of a desired type can intuitively be instruction by touch, weight or the like even if the user does not know the type (for example, paper quality such as glazed paper or plain paper) of the printing medium the user wishes to print.

It is considered that printing is instruction by the print instructing medium based on the image modification instruction information on which the printer cannot carry out printing and the printing medium instruction information. In this case, the printing instruction on which printing cannot be carried out is delivered. In view of the problem, model information of the printer to be caused to execute printing is acquired by the model information acquiring unit. The model information is compared with at least one of the printing medium instruction information and image modification instruction information. The printing instruction is corrected according to results of the comparison. As a result, the printing instruction can be corrected so as to comply with the model information of the printer which executes printing, whereby printing can reliably be carried out by the printer. For example, when the printer can print on the paper whose size is up to a maximum paper size of A4, it can be considered that A3 size is instruction by the printing medium instruction information. In this case, the maximum paper size (A4) and the printing medium instruction information of A3 size are compared with each other. As a result, the printing instruction to be delivered is corrected so that A3 size is converted to A4 size.

The printing is basically instruction based on the printing medium instruction information and the image modification instruction information represented by the print instructing medium. However, it can be considered that these pieces of instruction information do not completely meet user's intention. However, predetermined UI display is carried out by a receiving unit so that instructions are received from the user or the like according to the UI display and so that the printing instruction is corrected. As a result, the printing instruction can improve the degree of satisfaction of the user.

Furthermore, it is desirable that the user can intuitively recognize the contents of the image modification instruction information represented by the printing instructing medium. For example, a sample of image processing carried out based on the image modification instruction information may be represented on the print instructing medium so as to be visible. If the sample of the image processing to be actually carried out is represented, the user can intuitively find what image processing is to be carried out. Only a sample after execution of the image processing may be displayed or samples before and after the image processing may be displayed in comparison. Furthermore, as another technique, characters or icon representative of at least one of the printing medium instruction information and the image modification instruction information may visibly be represented on the print instructing medium. As a result, the user can readily select the print instructing medium.

It is a matter of course that the technical idea of the invention is realized in a print control method carried out in a print control device. Furthermore, the print control method may be realized using a microcomputer by loading a print control program onto the microcomputer so that predetermined functions are performed. Still furthermore, the technical idea of the invention may be realized in another device, method or program each of which has the above-described print control device, print control method or print control program as a part thereof For example, the effects of the invention can also be achieved in a printer which includes the print control device as a part thereof More specifically, the invention may be realized in a direct printer also serving as a printing unit. Furthermore, units, steps or functions possessed by the print control device, print control method or print control program may be shared by a plurality of devices. For example, a part of the functions may be realized by a printer driver of a personal computer and another part of the functions may be realized by firmware of the printer. Additionally, the above-described image input unit may be included in a device such as a mobile telephone with a camera function and the other units may be realized in a personal computer or a printer.

### D. First Modified Form

The foregoing description exemplifies the case where all pieces of instruction information composing the instruction information set are read by the barcode α1. However, the instruction information may be read by other means. Of course, part of instruction information may be read by a barcode and the other instruction information may be read by a reader unit. For example, the control circuit 260 may execute an optical character recognition (OCR) and recognize instruction information set by recognizing scanned image data by characters. In this case, a UI sheet on which characters are previously printed may be used or a UI sheet on which the user designates the conditions by handwriting.

Furthermore, the printing instruction medium can be read by directly measuring physical characteristics of the UI sheet. For example, ends of the UI sheet is detected in the scanned image data acquired at step S150. The paper size of the UI sheet can be determined by measuring a distance between the ends. The size of the UI sheet can be obtained by multiplying the number of pixels between the ends by the resolution of the scanned image data. Furthermore, a light source and an optical sensor (see International Publication No. 2005/0160048) may be provided near the platen glass 104 of the scanner section 100 so that a reflection characteristic including positive reflection light and diffused reflection light. According to the reflection characteristic, the physical characteristics such as the thickness, glaze, surface roughness and color of the UI sheet can be measured. Types of printing papers having different paper qualities can be read based on these characteristics.

### E. Second Modified Form

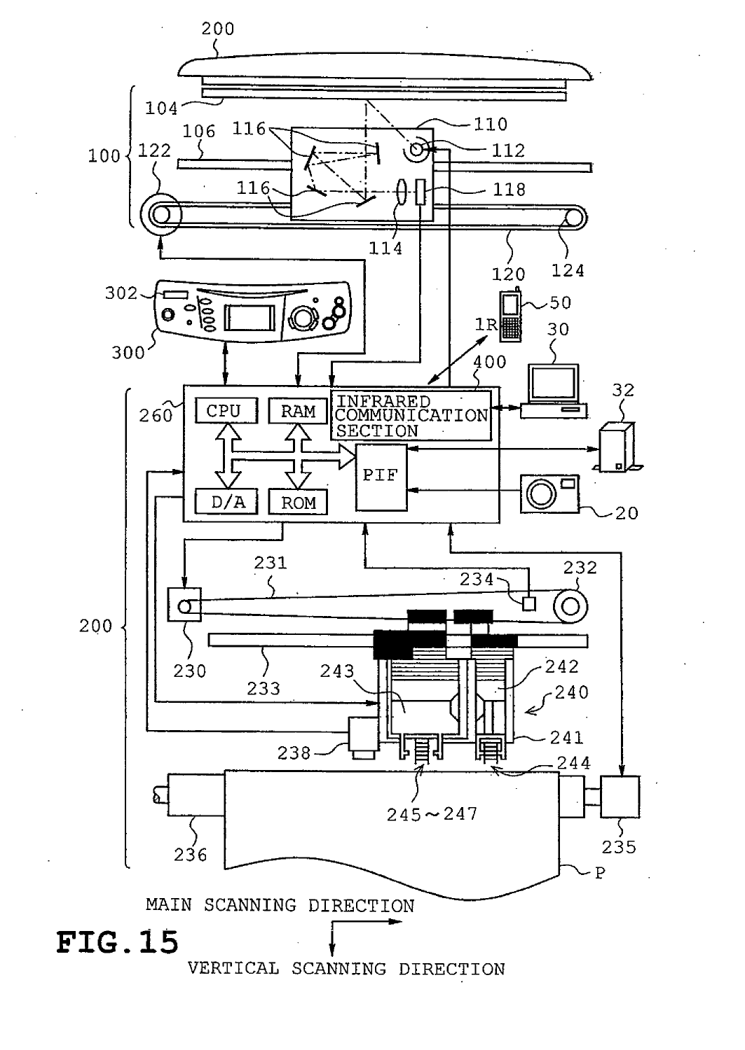

FIG. 15 shows an arrangement of the print control system of a second modified form. In the figure, an infrared communication section 400 is provided in the printer 10 having substantially the same arrangement as in the foregoing embodiment. Communication can be executable between a mobile phone 50 and the control section 260 via the infrared communication section 400. The infrared communication section 400 includes an element which can be capable of emitting infrared rays, and the mobile phone 50 also includes an infrared communication section corresponding to the infrared communication section 400. The mobile phone 50 is provided with a camera function so as to be capable of image input by a camera provided with a dot-matrix light detecting element.

In the above-described arrangement, an image of the barcode α1 as shown in FIG. 9 is taken by the mobile phone 50, and data of the taken image is transmitted to the printer 10. The control section 260 of the printer 10 decodes an image of the barcode α1 contained in the taken image data, thereby determining instruction information sets PR1 to PR16. Image modification processing and print data generating processing are carried out based on the instruction information sets PR1 to PR16. As a result, even when the printer 10 is not provided with the scanner section 100, the advantages of the invention can be achieved. The invention should not be limited to the mobile phone 50 in which the taken image data is transmitted via infrared communication. The mobile phone 50 may decode the barcode α1 and transmit the instruction information sets PR1 to PR16 via the infrared communication.

### F. Third Modified Form

In the foregoing embodiment, printing is carried out when the UI sheet has been scanned. In this while, the user need not operate the printer. However, there is a case where any one of the instruction information sets PR1 to PR16 does not meet the user's demand. Accordingly, advanced-level users prefer a semiautomatic processing rather than a fully automatic processing.

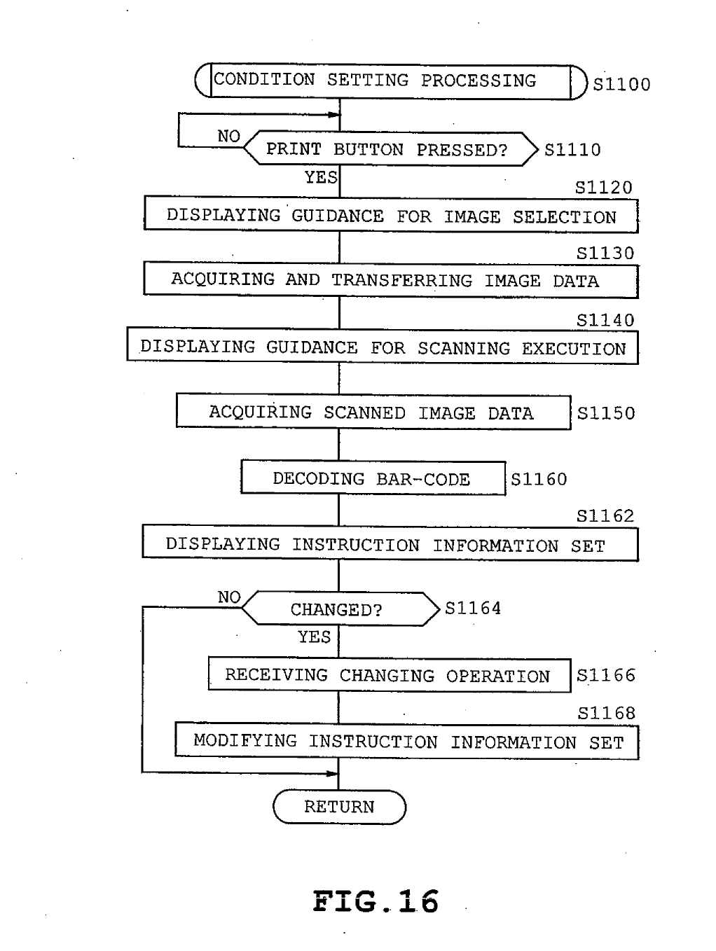

FIG. 16 is a flowchart showing a condition setting process in a third modified form. In the figure, the UI sheet is scanned so that the instruction information sets PR1 to PR16 are recognized (step S1160). The recognized instruction information sets PR1 to PR16 are displayed on the screen of the operation panel 300 (step S1162). On the screen is then displayed a UI display that “Printing conditions have been set. Depress execution button unless changed or depress change button when you make any change.” When depression of the execution button has been accepted (step S1164), the image modification processing and the print data generating processing are executed according to the instruction information sets PR1 to PR16 read from the barcode α1.

On the other hand, when depression of the change button has been accepted (step S1164), a screen for setting print conditions is displayed, and operation onto the operation panel 300 serving as an accepting unit is accepted (step S1166). Initially read instruction information sets PR1 to PR16 are corrected in response to accepted instruction of the user (step S1168). As a result, detailed setting can manually be corrected by the user while rough setting is carried out by scanning the UI sheet. In this case, too, not all the conditions need be entered via the operation panel 300 and accordingly, troublesomeness can be relieved for the user.

### G. Fourth Modified Form

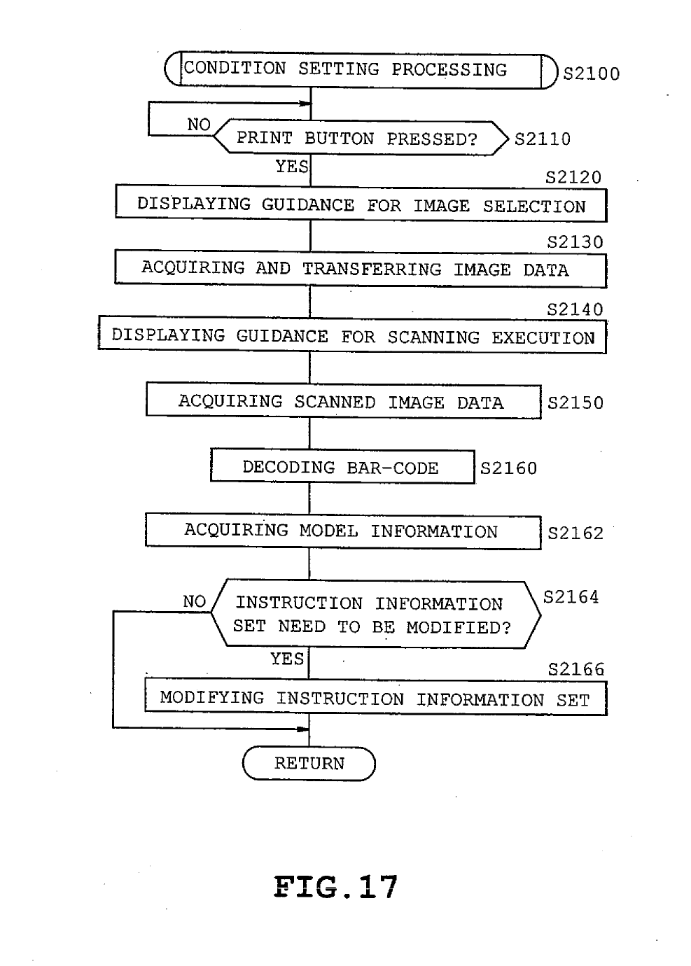

FIG. 17 is a flowchart showing a condition setting process in a fourth modified form. In the figure, UI sheet is scanned so that the instruction information sets PR1 to PR16 are recognized (step S2160). The control section 260 as a model information acquiring unit of the invention acquires model information of the printer 10 (step S2162). The model information is stored, for example, on the ROM of the control section 260 and is indicative of information about specification specific to the model of the printer 10. More specifically, specification information to be obtained contains a size limitation of printing paper on which the printer 10 can print, a limitation of resolution and the like. In the modified form, the instruction information set PR1 is acquired, and a printing-paper size limitation of 2L size and a resolution limitation of 1440×1440 dpi are obtained.

Subsequently, the control section 260 compares the instruction information set PR1 and the specification information, thereby determining whether printing conditions need to be corrected (step S2164). In the modified form, the paper size of A4 indicated by the instruction information set PR1 exceeds the limitation of specification of the printer 10, 2L size. Consequently, the control section 260 determines that correction is necessitated (step S2166). On the other hand, a high mode of printing resolution indicated by the instruction information set PR1 does not exceed the limit of 1440×1440 dpi. As a result the resolution of high mode instruction in the print data generating processing remains unchanged. Furthermore, if the model information is obtained as in the modified form, abstract conditions can be instruction by the UI sheet as well as the concrete conditions. For example, the printing resolution may be instruction as the maximum printing resolution but not as the specific numeric value such as 1440×1440 dpi. In this case, the maximum printing resolution in the model is set based on the model information the control section has acquired.

### H. Modified Forms of UI Sheet

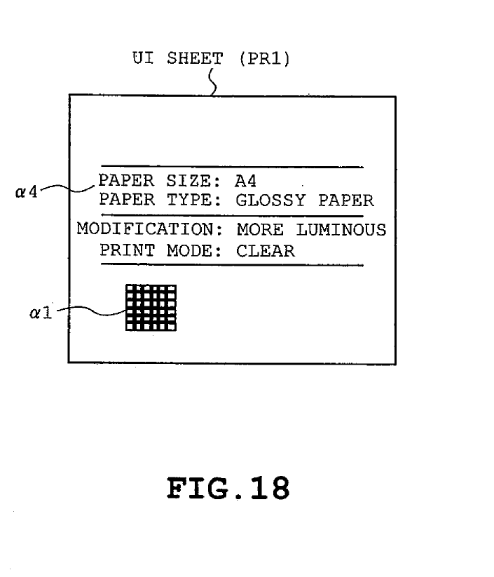

FIG. 18 shows a UI sheet of a modified form. In the figure, for example, only the barcode α1 and characters α4 are represented on a piece of paper having a size as large as a business card. More specifically, neither sample image nor icon is represented on the UI sheet of the modified form. The UI sheet exemplified in FIG. 18 designates the same conditions as of the instruction information set PR1 described in the foregoing embodiment, and the barcode α1 also corresponds to that of the instruction information set PR1. Accordingly, the instruction information set PR1 is recognized by the control circuit 260 when the barcode α1 of the UI sheet of the modified form is scanned. On the other hand, all pieces of instruction information composing the instruction information set PR1 are represented by the characters α4 on the UI sheet. Accordingly, the user reads the characters α4 and causes the control circuit 260 to scan the UI sheet with the desired conditions, whereupon printing can be executed based on the conditions. The UI sheet can be formed into a compact size when the instruction information set is represented by the least characters α4.

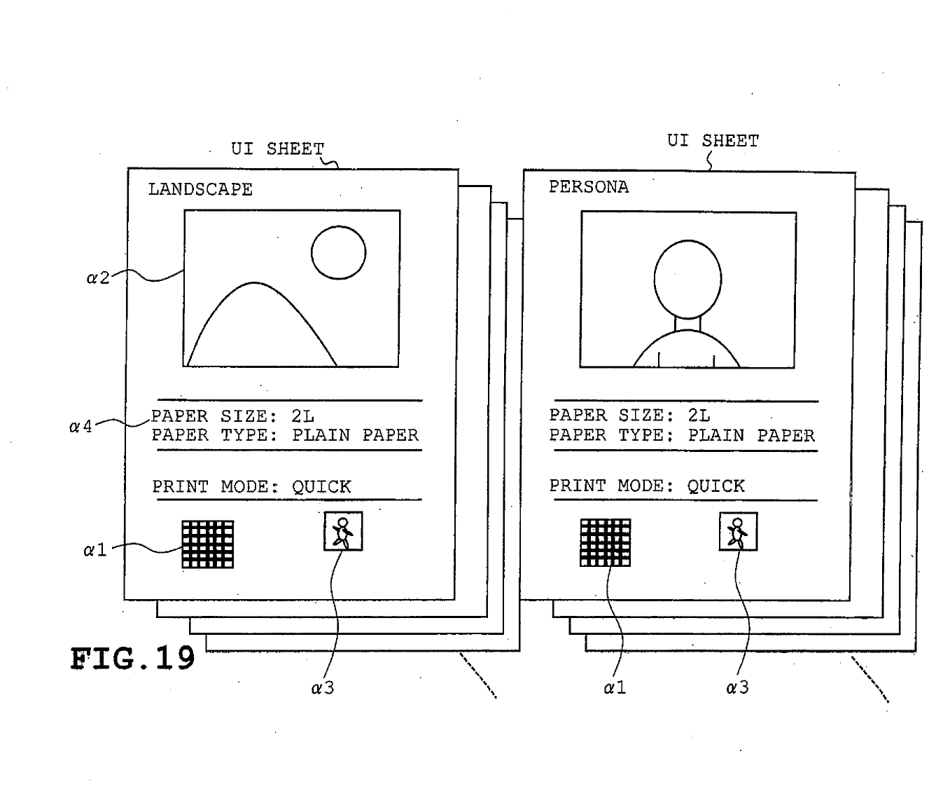

FIG. 19 also shows a UI sheet of another modified form. In the figure, two systems of UI sheets are prepared. One system of LT1 sheets represents a scenic picture as a sample image α2 for instruction of image modification. The other system of UI sheets represents a figure picture as a sample image α2. When the UI sheet representing the scenic picture as the sample image α2 is scanned, the control section 260 recognizes that image modification (for example, contrast enhancement, edge enhancement, achromatic enhancement or the like) suitable for the scenic picture should be carried out. On the other hand, when the UI sheet representing the figure picture as the sample image α2 is scanned, the control section 260 recognizes that image modification (for example, red-eye effect correction, backlight correction or the like) suitable for the figure picture should be carried out. In this configuration, when the user selects the sample image α2 resembling the image data to be printed, image modification suitable for the image data is carried out without direct instruction of contents of image modification.

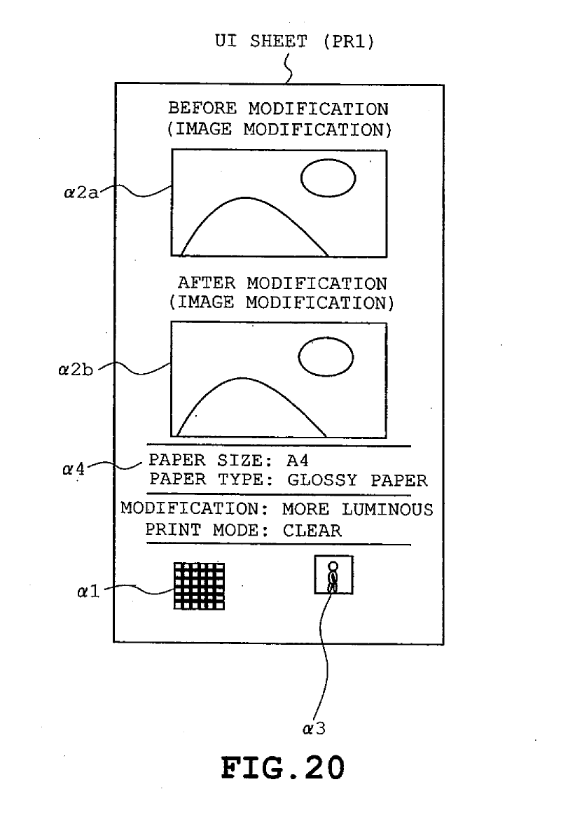

FIG. 20 shows a UI sheet of further another modified form. In the figure, two sample images α2a and α2b are printed on the UI sheet. The UI sheet as exemplified on FIG. 20 designates the same conditions as the instruction information set PR1 in the foregoing embodiment, and the barcode α1 also corresponds to that of the instruction information set PR1. The sample image α2a represents a reference image, whereas the sample image α2b represents an image generated by applying a tone curve TC1 as shown in FIG. 11 to the reference image. More specifically, the images before and after the image modification process are contrasted with each other. Consequently, the user can intuitively grasp to how the image modification processing should be carried out by scanning the UI sheet.

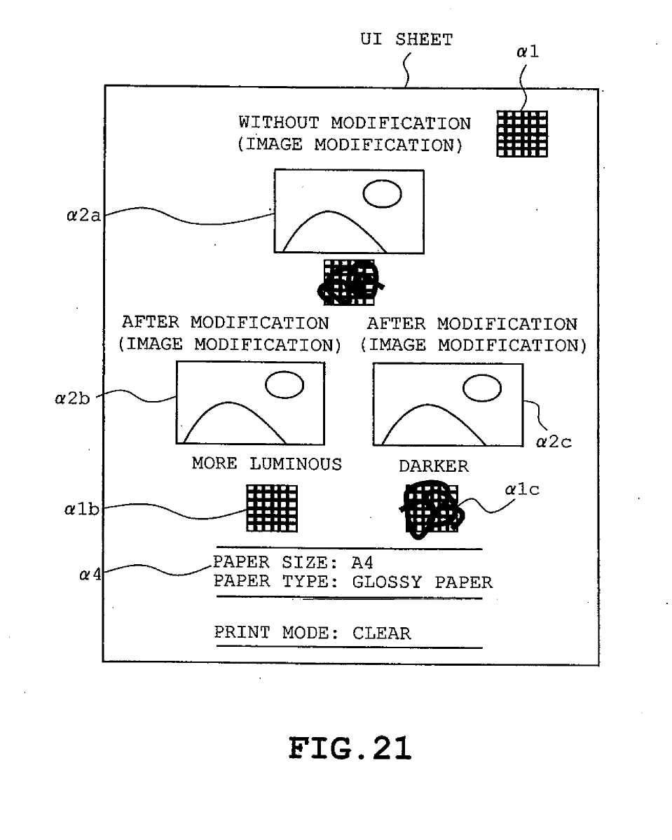

FIG. 21 shows a UI sheet of still further another modified form. In the figure, three sample images α2a, α2b and α2c are printed on the UI sheet. The sample images α2a and α2b represent a reference image and an image obtained by applying a tone curve TC1 to the reference image. The sample images α2a and α2b are the same as those in the foregoing modified form. On the other hand, the sample image α2c is obtained by applying a tone curve correcting the reference image by reducing the luminance relative to the reference image and by increasing the luminance relative to the reference image. More specifically, the sample images corrected so as to be brighter and darker than the reference image and the reference image are arranged. Furthermore, barcodes α1a, α1b and α1c are formed beneath the respective sample images α2a, α2b and α2c.

Another barcode α1 is formed on the upper left corner of the UI sheet. Printing resolution instruction information and printing medium instruction information can be obtained as decoded forms from the barcode α1 on the upper left corner. When this UI sheet is scanned, the barcodes α1a, α1b and α1c beneath the sample images α2a, α2b and α2c for which the user does not desire image modification are marked out so that the barcodes α1a, α1b and α1c are unrecognizable.

For example, when the user desires a correction to render an image brighter, the barcodes α1a and α1c are marked out so as to be unrecognizable. The barcode α1a is formed beneath the uncorrected sample image α2a and the barcode α1c is formed beneath the sample image which has been corrected so as to be darker. Consequently, the control section 260 recognizes only the barcode α1b designating correction rendering an image brighter and further recognizes the tone curve TC1 to be applied. The other instruction information can be obtained from the barcode α1 formed on the upper right corner. Printing can be executed by complete instruction information at PR1. As a result, the degree of image modification can intuitively be compared and alternative elements can be instruction on the same UI sheet. Accordingly, the necessary number of UI sheets can be reduced. A technique for rendering the barcodes α1a, α1b and α1c unrecognizable should not be limited to marking out. For example, parts of the barcodes α1a, α1b and α1e may be cut out or hidden by impermeable stickers. In the latter technique, the UI sheet can be re-used by tearing off the sticker.

What is claimed is:

1. A print control device that controls execution of a printing operation on a printing medium, comprising:
an instruction information acquiring unit that acquires an image of a printing instruction medium and acquires image modification instruction information and printing medium instruction information according to the image;
an image modification unit that modifies an image data to be printed based on at least the image modification instruction information; and
a printing instruction unit that is operable of issuing a printing instruction so that a printing of the image data is carried out on the printing medium specified based on the printing medium instruction information.

2. The print control device according to claim 1, wherein the printing medium instruction information includes at least information for specifying a size of the printing medium obtained by measuring a size of the image of the printing instruction medium.

3. The print control device according to claim 1, wherein the printing medium instruction information includes at least information for specifying a type of the printing medium obtained by calculating a light reflection characteristic of the printing instruction medium.

4. The print control device according to claim 1, wherein at least either the image modification instruction information or the printing medium instruction information is represented by a barcode decoded by the instruction information acquiring unit.

5. The print control device according to claim 1, further comprising a model information acquiring unit that acquires model information of a printer to execute the printing of the image data, wherein the printing instruction unit modifies the printing instruction according to a comparison of at least either the printing medium instruction information or the image modification instruction information with the model information.

6. The print control device according to claim 1, further comprising a receiving unit that receives a supplemental instruction by a predetermined user interface (UI) display, wherein the printing instruction unit modifies the printing instruction according to the supplemental instruction.

7. The print control device according to claim 1, wherein a sample image that is modified based on the image modification instruction information is represented so as to be viewable on the printing instruction medium.

8. The print control device according to claim 1, wherein a character or an icon that is representative of at least either the printing medium instruction information or the image modification instruction information is viewable on the printing instruction medium.

9. A method of controlling execution of a printing operation for a printing medium, comprising:
acquiring an image of a printing instruction medium;
acquiring image modification instruction information and printing medium instruction information according to the image;
modifying an image data to be printed based on at least the image modification instruction information; and
issuing a printing instruction so that a printing of the image data is carried out on the printing medium specified based on the printing medium instruction information.
